(19) United States
(12) Patent Application Publication
(10) Pub. No.: US 2026/0128449 A1
(43) Pub. Date: May 7, 2026

(54) BATTERY PACK FOAM SHIELD ASSEMBLY

(71) Applicant: Ford Global Technologies, LLC, Dearborn, MI (US)

(72) Inventors: Bhaskara Rao Boddakayala, Troy, MI (US); Di Zhu, Novi, MI (US)

(21) Appl. No.: 18/935,965

(22) Filed: Nov. 4, 2024

(51) Int. Cl. H01M 50/293; H01M 10/658; H01M 50/233; H01M 50/291; H01M 50/507

(52) U.S. Cl. CPC H01M 50/293; H01M 10/658; H01M 50/233; H01M 50/291; H01M 50/507; H01M 2200/10

(57) ABSTRACT

A battery pack assembly includes an enclosure assembly that provides an interior area. Battery cells are disposed along an array axis and are positioned within the interior area. Each of the battery cells includes at least one tab terminal that projects outward from the array axis. A shield assembly includes a foam secured to a support rod. The shield assembly is alongside the battery cells within the interior area.

### TECHNICAL FIELD

This disclosure relates generally to a shield assembly used within a battery pack and, more particularly, to a shield assembly that incorporates foam along with a support rod, additive agent, or both.

### BACKGROUND

A high voltage traction battery pack can power the electric machines and other electrical loads of an electrified vehicle. The traction battery pack can include a plurality of individual battery cells. The traction battery pack can, from time to time, experience a thermal event where one or more of the battery cells vent and expel battery vent byproducts. The vent byproducts can include gases and effluent particles.

### SUMMARY

In some aspects, the techniques described herein relate to a battery pack assembly, including: an enclosure assembly that provides an interior area; a plurality of battery cells disposed along an array axis and disposed within the interior area; each of the plurality of battery cells including at least one tab terminal that projects outward from the array axis; and a shield assembly including a foam secured to a support rod, the shield assembly alongside the plurality of battery cells within the interior area.

In some aspects, the techniques described herein relate to a battery pack assembly, wherein the shield assembly is between the plurality of battery cells and at least one busbar.

In some aspects, the techniques described herein relate to a battery pack assembly, further including a frame providing at least one slot that receives a portion of the at least one tab terminal, and at least one busbar secured to the frame, the frame disposed between the at least one busbar and the shield assembly.

In some aspects, the techniques described herein relate to a battery pack assembly, wherein the shield assembly is secured directly to the frame.

In some aspects, the techniques described herein relate to a battery pack assembly, wherein the shield assembly includes at least one alignment foot.

In some aspects, the techniques described herein relate to a battery pack assembly, wherein the foam is tapered.

In some aspects, the techniques described herein relate to a battery pack assembly, wherein the shield assembly includes at least one additive agent that is configured to release in response to a thermal event proximate the shield assembly.

In some aspects, the techniques described herein relate to a battery pack assembly, wherein the at least one additive agent is mixed with the foam.

In some aspects, the techniques described herein relate to a battery pack assembly, wherein the at least one additive agent includes silica, aerogel, mica, basalt, or some combination of these.

In some aspects, the techniques described herein relate to a battery pack assembly, wherein the at least one additive agent is configured to electrically isolate, block a transfer of thermal energy, or both.

In some aspects, the techniques described herein relate to a battery pack assembly, wherein the at least one additive agent includes melamine poly(zinc phosphate).

In some aspects, the techniques described herein relate to a battery pack assembly, wherein the support rod is a polymer-based material.

In some aspects, the techniques described herein relate to a battery pack assembly, wherein at least one end portion of the support rod protrudes outside the foam.

In some aspects, the techniques described herein relate to a battery pack assembly, wherein the foam is a precast foam.

In some aspects, the techniques described herein relate to a battery pack assembly, including: an enclosure assembly that provides an interior area; a plurality of battery cells disposed along a array axis and disposed within the interior area; each of the plurality of battery cells including at least one tab terminal that projects outward from the array axis; and a shield assembly including a foam and at least one additive agent dispersed within the foam.

In some aspects, the techniques described herein relate to a battery pack assembly, wherein the foam is a precast foam.

In some aspects, the techniques described herein relate to a battery pack assembly, wherein the foam of the shield assembly is supported on a support rod of the shield assembly.

In some aspects, the techniques described herein relate to a battery pack assembly, wherein the at least one additive agent is configured to electrically isolate, block a transfer of thermal energy, or both.

In some aspects, the techniques described herein relate to a battery pack assembly, wherein the at least one additive agent includes melamine poly(zinc phosphate).

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded, perspective view of a battery pack from the electrified vehicle of FIG. 1.

FIG. 3 illustrates a schematic, top view of a portion of a battery array of the battery pack of FIG. 2 and shows how a plurality of shields are incorporated into a battery pack.

FIG. 4 illustrates a perspective view of a shield from the battery pack of FIG. 3.

FIG. 5 illustrates a section view at line 5-5 in FIG. 4.

### DETAILED DESCRIPTION

This disclosure is directed toward a shield assembly used in a battery pack. The shield assembly includes foam. In an example, the shield can block thermal energy and particulate matter from reaching busbars of the battery pack. In examples, the shield assembly can include at least one additive agent dispersed within the foam and released in response to a thermal event within the battery pack. The foam of the shield can be supported by a support rod.

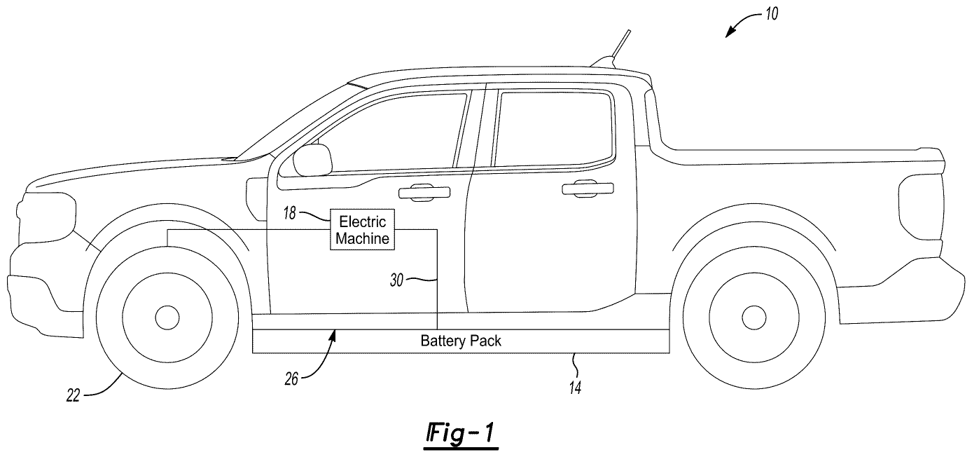

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples. A voltage bus 30 electrically couples the electric machine 18 to the traction battery pack 14.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

In the illustrated embodiment, the electrified vehicle 10 is a full electric vehicle propelled solely through electric power, such as by one or more electric machines 18, without assistance from an internal combustion engine. The electric machine 18 may operate as an electric motor, an electric generator, or both. The electric machine 18 receives electrical power and can convert the electrical power to torque for driving one or more wheels 22 of the electrified vehicle 10.

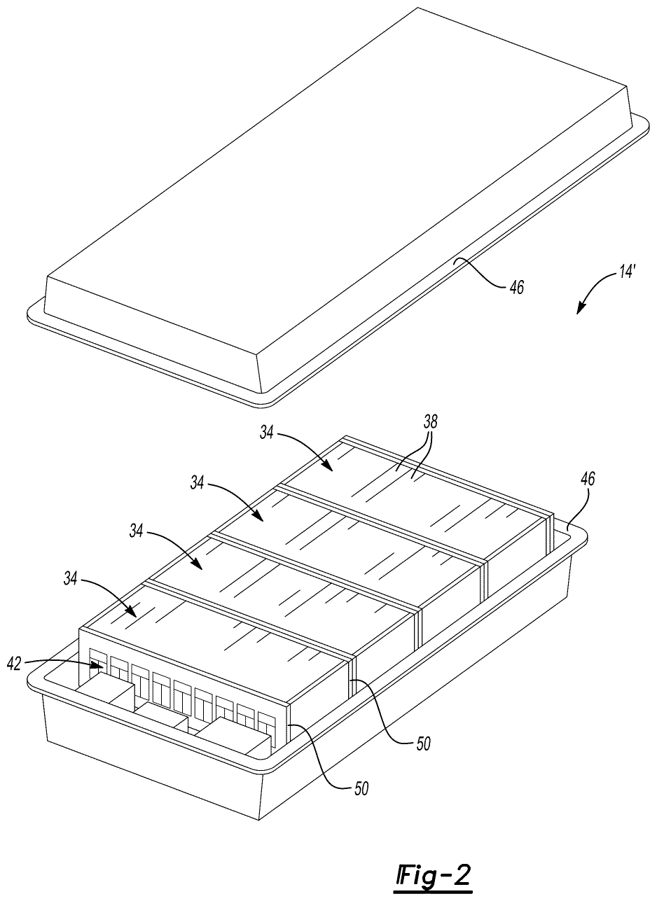

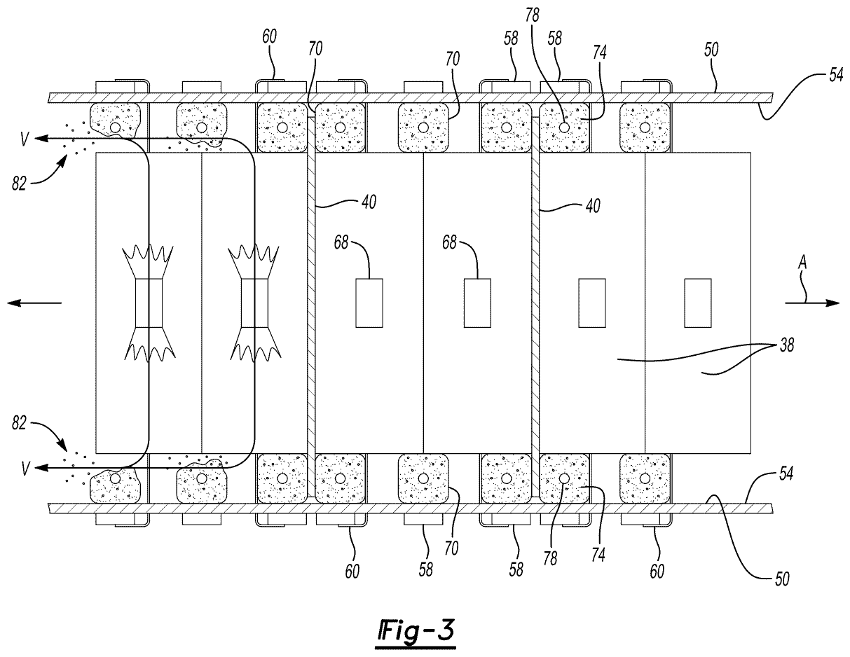

With reference to FIGS. 2 and 3 and continued reference to FIG. 1, the example traction battery pack 14 includes battery arrays 34 capable of outputting electrical power to power the electric machine 18 and/or other electrical loads of the electrified vehicle 10. Other types of energy storage devices and/or output devices could alternatively or additionally be used to electrically power the electrified vehicle 10.

The one or more battery arrays 34 of the traction battery pack 14 each include a plurality of battery cells 38 that store energy for powering various electrical loads of the electrified vehicle 10. Each of the battery arrays 34 includes, among other things, battery cells 38 (or simply “cells”) stacked side-by-side relative to each along a respective battery array axis. The battery cells 38 store and supply electrical power. Within each of the battery arrays 34, groups of one or more of the cells 38 can be separated from each other by a thermal barrier 40.

Although a specific number of the battery arrays 34 and cells 38 are illustrated in the various figures of this disclosure, the battery pack 14 could include any number of the battery arrays 34 each having any number of individual cells 38.

The traction battery pack 14 could employ any number of battery cells 38 and battery arrays 34. Accordingly, this disclosure should not be limited to the configuration shown in FIGS. 2 and 3.

In an embodiment, the battery cells 38 of each battery array 34 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 34 and various other battery internal components (e.g., bussed electrical center, battery electric control module, wiring, connectors, etc.) may be housed within an interior area 42 of an enclosure assembly 46. The enclosure assembly 46 may include an enclosure cover and an enclosure tray, for example. The enclosure cover may be secured (e.g., bolted, welded, adhered, etc.) to the enclosure tray to provide the interior area 42. The size, shape, and overall configuration of the enclosure assembly 46 is not intended to limit this disclosure.

Within the interior area 42, the battery arrays 34 are each positioned between a pair of busbar modules 50, which each have a frame 54 and plurality of individual busbars 58 mounted to the frame 54. Tab terminals 60 of the battery cells 38 project outward from the battery array axis extend through slots in the frame 54 and are folded over the busbars 58. The busbars 58 and tab terminals 60 can be connected together via welds.

During a thermal event, one or more of the battery cells 38 may periodically release vent byproducts V (FIG. 3) through a vent 68. The vent byproducts V can include gas and particulate matter. This disclosure is primarily directed to shielding area of the battery pack 14 from the vent byproducts V, particularly the busbars 58.

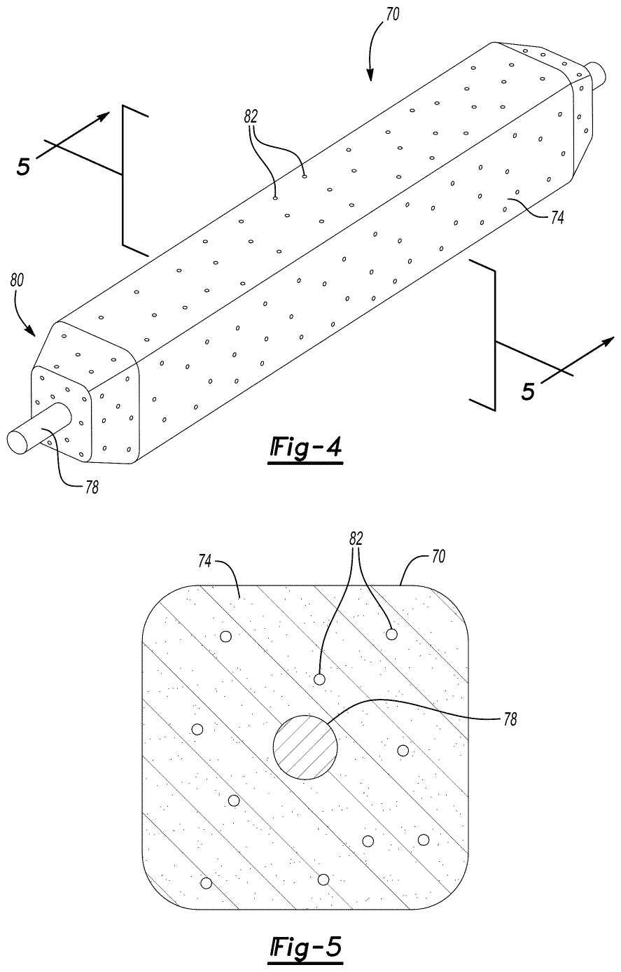

Referring now to FIGS. 4 and 5, and with continuing reference to FIGS. 2 and 3, the example battery arrays 34 each include a thermal suppression system for managing thermal energy transfer across the battery arrays 34. The example thermal suppression system includes a plurality of shield assemblies 70 that can be strategically positioned within the battery array 34. Among other things, the shield assemblies 70 can manage the transfer of thermal energy during venting events. For example, the shield assemblies 70 can be configured to mitigate the cell-to-cell and/or array-to-array transfer of thermal energy when one or more of the battery cells 38 in the battery arrays 34 release vent byproducts V.

Each shield assembly 70 in this example includes foam 74 secured to a support rod 78. The example shield assemblies 70 are positioned alongside the battery cells 38 within the interior area 42 of the enclosure assembly 46. The shield assemblies 70 could be incorporated into other spaces within the interior area 42 in other examples.

In the example embodiment, at least some of the shield assemblies 70 are positioned between cell tab terminals 60 of adjacent battery cells 38, or between the cell tab terminals 60 of one of the battery cells 38 and one of the thermal barriers 40 of the battery array 34. However, other arrangements are contemplated within the scope of this disclosure, and it should be understood that the shield assemblies 70 could be arranged within any void space within the interior area 42 where it is desirable to limit thermal energy transfer.

In this specific exemplary embodiment, the shield assemblies 70 are positioned between the battery cells 38 and the busbars 58. The frame 54 holding the busbars 58 can be disposed between the shield assemblies 70 and the busbars 58. The shield assemblies 70 in some examples, can be secured directly to the frame 54 utilizing adhesive for example. The shield assemblies 70 can include at least one alignment foot 86, which can be a portion of the foam 74, a portion of the support rod 78, or some other structure. The alignment foot 86 is shown in broken lines in FIG. 4.

The foam 74 of the shield assemblies 70 can be a precast foam. The foam 74 can be secured directly to the support rod 78. With the battery pack 14, the foam 74 can compress to accommodate expansion of the battery cells 38.

In an example, the support rod 78 is a polymer-based material. The example support rod 78 has a cylindrical cross-section having a diameter that is from 2-3 millimeters, but other cross-sections and sizes are possible. The support rod 78 protrudes past the foam 74 at a first end of the shield assembly 70, and at an opposite, second end of the shield assembly 70.

During assembly, the support rods 78 can be grasped and helped to move the shield assembly 70 into an installed position. An operator can grasp the support rods 78 of each of the shield assemblies 70 and insert the shield assembly 70 into a desired position. The support rod 78 is thus an installation aid. In some examples, an automated gripper assembly could grasp the support rod 78 of a plurality of shield assemblies 70 for insertion into the installed position.

The foam 74 of the example shield assemblies 70 includes a tapered area 80 at least one end. The taper can help to facilitate installation by guiding the shield assembly 70 into a desired area within the interior area 42.

During assembly of the shield assembly 70, the support rod 78 can be positioned within a mold cavity. Foam 74 that is uncured is then introduced into the mold cavity around the support rod 78. The foam 74 cures in a position where the foam 74 is secured to the support rod 78.

The foam 74 can be a precast foam. In some examples, the foam 74 is a two-part expandable silicone foam, or a closed cell non-halogenated, two-part polyurethane foam. The foam 74 can be mixed with isocyanate.

At least one additive agent 82 is incorporated into the foam 74 of the example shield assemblies 70. The additive agent 82 is configured to release from the shield assembly 70 in response to a thermal event proximate the shield assembly 70 within the interior area 42. The additive agent 82 can electrically isolate, can block a transfer of thermal energy, or both. The additive agent 82 could be silica, aerogel, mica, basalt, or some combination of these. In a specific example, the additive agent 82 can be a melamine poly(zinc phosphate).

The additive agent 82 can be released when the shield assembly 70 is exposed to temperatures that exceed a predefined temperature threshold (e.g., from 150 to 250 degrees Celsius). Temperatures may exceed such thresholds during a thermal event when one or more battery cells 38 near the shield assembly 70 is venting the vent byproducts V.

Once released, the additive agent 82 can capture or trap particles associated with the vent byproducts V thereby managing or even preventing the transfer of thermal energy toward battery cells 38 of the battery array 34 that are not venting.

The foam 74 can withstand relative high temperature thermal events due to the at least one additive agent 82 within the foam 74. The at least one additive agent 82 can be provided in bead, particulate, and/or powder form, for example.

The at least one additive agent 82 that are released can include endothermic materials and materials that help to electrically isolate. Example materials can include sodium silicate, a ceramic-based compound, melamine poly(zinc phosphate), aluminum tri-hydrate, and silicon dioxide. Other potential agents included within the at least one additive agent 82 could include silica, mica, basalt, aerogels, etc.

The shield assemblies 70 can, in addition to releasing the additive agent 82, block and trap particulate matter within the vent byproducts V. Blocking and trapping this particulate matter prevents the particulate matter from moving outward to the busbars 58 and from moving along the axis A toward other cells 38. As can be appreciated, the particulate matter can include conductive particles. Blocking the conductive particles from contacting or being directly adjacent to the busbars 58 can help prevent the conductive particles from becoming a conductor within the interior area 42.

In some more specific examples, the at least one additive agent 82 within the foam 74 can include from 90-95 percent two-part silicone. 0.5-3.0 percent of the at least one additive agent 82 can be sodium silicate granules that range from 5 to 100 microns in diameter. These granules can absorb thermal energy during a thermal event. 0.5-0.9 percent of the at least one additive agent 82 can be compound ceramic beads that are each more than 10 percent zirconium dioxide, more than 45 percent aluminum oxide, and more than 45 percent silicon dioxide. A diameter of the compound ceramic beads can be from 0.1-0.5 microns. 1.0 percent of the at least one additive agent 82 can be aluminum oxide particles that have diameters from 5 to 30 microns. These particles can facilitate electrical isolation. 0.5-1.0 of the at least one additive agent 82 can be polyzinc phosphate that, when released, can generate nitrogen gas to arrest oxygen.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
an enclosure assembly that provides an interior area;
a plurality of battery cells disposed along an array axis and disposed within the interior area; each of the plurality of battery cells including at least one tab terminal that projects outward from the array axis; and
a shield assembly including a foam secured to a support rod, the shield assembly alongside the plurality of battery cells within the interior area.

2. The battery pack assembly of claim 1, wherein the shield assembly is between the plurality of battery cells and at least one busbar.

3. The battery pack assembly of claim 2, further comprising a frame providing at least one slot that receives a portion of the at least one tab terminal, and at least one busbar secured to the frame, the frame disposed between the at least one busbar and the shield assembly.

4. The battery pack assembly of claim 3, wherein the shield assembly is secured directly to the frame.

5. The battery pack assembly of claim 1, wherein the shield assembly includes at least one alignment foot.

6. The battery pack assembly of claim 1, wherein the foam is tapered.

7. The battery pack assembly of claim 1, wherein the shield assembly includes at least one additive agent that is configured to release in response to a thermal event proximate the shield assembly.

8. The battery pack assembly of claim 7, wherein the at least one additive agent is mixed with the foam.

9. The battery pack assembly of claim 7, wherein the at least one additive agent comprises silica, aerogel, mica, basalt, or some combination of these.

10. The battery pack assembly of claim 7, wherein the at least one additive agent is configured to electrically isolate, block a transfer of thermal energy, or both.

11. The battery pack assembly of claim 7, wherein the at least one additive agent comprises melamine poly(zinc phosphate).

12. The battery pack assembly of claim 1, wherein the support rod is a polymer-based material.

13. The battery pack assembly of claim 1, wherein at least one end portion of the support rod protrudes outside the foam.

14. The battery pack assembly of claim 1, wherein the foam is a precast foam.

15. A battery pack assembly, comprising:
an enclosure assembly that provides an interior area;
a plurality of battery cells disposed along a array axis and disposed within the interior area; each of the plurality of battery cells including at least one tab terminal that projects outward from the array axis; and
a shield assembly including a foam and at least one additive agent dispersed within the foam.

16. The battery pack assembly of claim 15, wherein the foam is a precast foam.

17. The battery pack assembly of claim 15, wherein the foam of the shield assembly is supported on a support rod of the shield assembly.

18. The battery pack assembly of claim 15, wherein the at least one additive agent is configured to electrically isolate, block a transfer of thermal energy, or both.

19. The battery pack assembly of claim 15, wherein the at least one additive agent comprises melamine poly(zinc phosphate).
